(19) United States
(12) Patent Application Publication
(10) Pub. No.: US 2008/0131684 A1
(43) Pub. Date: Jun. 5, 2008

(54) Thermal Radiation Shield For Vacuum And Protective Atmosphere Furnaces

(75) Inventors: Joerg Adler, Meissen (DE); Gisela Standke, Dresden (DE); Daniela Kopejzny, Meissen (DE); Guenter Stephani, Grosserkmannsdorf (DE); Kerstin Kuemmel, Dresden (DE); Wieland Beckert, Dresden (DE)

Correspondence Address: GREENBLUM & BERNSTEIN, P.L.C., 1950 ROLAND CLARKE PLACE, RESTON, VA, 20191, US

(73) Assignee: FRAUNHOFER-GESELLSCHAFT ZUR FOERDERUNG DER ANGEWANDTEN FORSCHUNG E.V., Muenchen (DE)

(21) Appl. No.: 11/813,532

(22) PCT Filed: Jan. 9, 2006
(86) PCT No.: PCT/EP06/50101

§ 371 Date: Jan. 3, 2008

(30) Foreign Application Priority Data
Jan. 10, 2005 (DE) 10 2005 001 502.6

(51) Int. Cl. F16L 59/08

(52) U.S. Cl. 428/312.8

(57) ABSTRACT

The invention relates to the field of mechanical engineering and refers to a radiation protective shield for vacuum furnaces and protective atmosphere furnaces, which shield is used for the best possible shielding from thermal radiation. The object of the present invention is to disclose thermal radiation protective shields of reduced weight with identical or lower effective emissivity. The object is attained by a thermal radiation protective shield for vacuum furnaces and protective atmosphere furnaces, composed of at least one porous ceramic and/or metallic material that has high thermal radiation-reflecting properties at least on a surface in the direction of the heat source.

The invention relates to the field of mechanical engineering and refers to a radiation protective shield for vacuum furnaces and protective atmosphere furnaces, which shield is used for the best possible shielding from thermal radiation.

With methods and devices for the thermal treatment of substances or workpieces, the heat source (heater) and the material to be treated are to be thermally shielded from the environment for reasons of effectiveness. At the same time, the environment (e.g., the furnace wall) must be protected against excessive thermal load.

Heat propagation occurs essentially through three principles: through propagation via heat conduction in substances (without movement of the substance), through convection (with movement of the substance) and through propagation via thermal radiation. The latter does not require a transmission medium, thus is also possible in vacuum.

For the reasons mentioned above, convection is limited or prevented for thermal insulation, and materials with low thermal conductivity and/or materials reflecting the thermal radiation are used as thermally insulating substances.

For the thermal insulation of thermal processes, substances with a thermally insulating effect are often inserted between the heat source and the environment to be protected, which substances impede a propagation of the heat. For thermal insulation in vacuum furnaces and protective atmosphere furnaces, heat transfer through convection and heat conduction play only a minor role, as the gaseous transmission medium does not exist or has bad heat conduction properties.

Transfer through heat conduction decreases with the temperature in most substances, whereas heat transfer by thermal radiation increases to the fourth power as the temperature rises according to the Stefan-Boltzmann Law, so that heat transfer through radiation has a very high impact particularly in the high-temperature range, i.e., in particular in vacuum furnaces and protective atmosphere furnaces.

Vacuum furnaces and protective atmosphere furnaces are thus insulated by so-called radiation protective shields of refractory metals, such as, e.g., Mo, W, Ta and alloys thereof, which have a relatively high thermal conductivity themselves, but shield the furnace walls from the thermal radiation of the heating conductor.

The ability of a material to emit thermal radiation is expressed by the emission coefficient ε, the ability to absorb heat by the absorption coefficient a. According to Kirchhoff s Law, the emission coefficient of a body equals the absorption coefficient. In the boundary cases that can be achieved only theoretically of ε=1 and ε=0, heat is absorbed/radiated or reflected completely. With radiation protective shields, the lowest possible ε-value is thus aimed for. ε depends both on the material used (as material characteristic) and on the surface condition of the material. Smooth surfaces have a lower emission coefficient than rough surfaces. Furthermore, ε also depends on the temperature, i.e., generally the value increases as the temperature rises.

The radiation protective shields are particularly used with furnaces in which the temperature treatment of substances and/or workpieces occurs under vacuum or protective gas, such as, e.g., nitrogen, hydrogen, inert gases or mixtures thereof, at pressures lower than the ambient pressure. An alternative use of known thermal insulation materials is unfavorable because these have a large internal surface, and it is difficult to remove the substances absorbed thereto in vacuum, so that it takes a very long time or is even impossible to achieve a high negative pressure in the furnace. Furthermore, these thermal insulation materials are often very voluminous and have a high heat capacity, which is why it takes a very long time to heat up and cool down the furnace. Here conventional thermal radiation protective shields have the advantage that they have a small surface and low heat capacity, which is why the furnaces can be heated up and cooled down quickly, and high vacuum values can be achieved.

Several thermal radiation protective shields are arranged one behind the other with intermediate free spaces and are located between the heat source and the area to be thermally protected. In a cylindrical furnace with cylindrical heating conductors, for example, several concentrically arranged sheets of molybdenum or tungsten are arranged at regular distances from one another between the heating conductors and the furnace wall. At the bottom and on the lid of the cylindrical furnace round molybdenum or tungsten sheets are arranged on top of one another.

The disadvantages with the use of thermal radiation protective shields are the high price of the sheets of refractory metals and the high weight of sheets of this type. It has thus been tried to use as little refractory metal as possible, e.g., by using thinner sheets. But there are limits to this, as these sheets must be of sufficiently high mechanical strength, so as not to deform during operation of the furnace and so as to carry the dead weight. Otherwise, complex support devices and fastening devices are also required in the furnace, which nullify the advantage again.

Furthermore, most thermal radiation protective shields embrittle after a short time, so that very thin sheets become highly sensitive to mechanical stress, e.g., as a result of thermally induced tensions or with manipulations in the furnace, and limit the service life of the shields.

Another reason for using several shields one behind the other is the fact that although the surface of the protective shields reflects the thermal radiation, this reflection is never complete. The protective shields thus also absorb a part of the thermal radiation and heat up themselves. Because of the relatively high thermal conductivity of the refractory metals, the heat absorbed on the side facing the heat source is conducted to the back of the protective shield and again radiated there. Only by means of cascading protective shields can a high thermal insulation be achieved. It is disadvantageous that many protective shields must be used, and that these are heavy and expensive.

With the above-mentioned refractory metals, there is only a very low, basically non-measurable temperature gradient between front and back of the individual shield as a result of the high thermal conductivity and the low thickness of the protective shields.

The effect of a thermal radiation protective shield in vacuum on the heat flow density j^{th} conducted through can be described for the case of a parallel arrangement of the protective shield between a flat heat source with temperature T₁ and the environment with temperature T₀ with an effective emissivity ε_{eff} (σ=Stefan-Boltzmann constant=5.67*10⁻⁸ W/m²K⁴) as:

j^{th}=ε_{eff}·σ·(T₁⁴−T₀⁴)

The influence of the surface emission coefficient ε, the thickness d and the internal thermal conductivity coefficient λ of the thermal radiation protective shield can be estimated approximately for the above-mentioned case according to the following equation (heat source assumed as “ideal black body” with ε=1):

$$\frac{1}{{ɛ}_{eff}} = \frac{2}{ɛ} + 4 \cdot σ \cdot {T}_{1}^{3} \cdot \frac{d}{λ} \cdot {( \frac{1}{2} + \frac{1}{2} \cdot \frac{{T}_{0}^{4}}{{T}_{1}^{4}} )}^{\frac{3}{4}}$$

The lower the effective emissivity of a thermal radiation protective shield, the less heat will pass through the shield. Typical values of thin thermal radiation protective shields for vacuum furnaces and protective atmosphere furnaces of molybdenum or tungsten are at ε_{eff}≧0.07, typically at >0.175, if highly polished shields are not used, which is complex and expensive. Because of the high thermal conductivity these values depend only to a very low extent on the thickness of the shield. Depending on the furnace size, sheets of 0.1 mm to 1 mm thickness are typically used, so that the weights per unit area for molybdenum sheets range from 1 to 10.4 kg/m² and for tungsten sheets from 1.9 to 19.3 kg/m².

AT-PS 279190 discloses radiation shields for high-temperature furnaces, with exchangeable corrugated sheets of high-melting metal being attached to a frame. The frames, however, again increase the weight and the expenses for the insulation.

DE 44 29 104 A1 describes the spacing, marked by ridges, of sheets for thermal shields. Essentially, the thermal insulation in air applications at relatively low temperatures is increased here, since the insulating gas (air) is thereby enclosed between the sheets/foils, and its convection is prevented.

In AT-PS 390688, non-woven fabrics, woven fabrics or meshes of metal wire are inserted between protective sheets in vacuum equipment in order to improve the heat conduction between the sheets and to render possible an improved and more homogeneous heat dissipation from a high-temperature heat source, which is in contrast to the desired function of the radiation protective shield according to the invention.

Other heat shields, e.g., in JP 09176821, are composed of a metallic base and a usually ceramic thermal insulation layer, with various intermediate layers for adhesion promotion and corrosion protection. The thermal insulation layer reduces the heat conduction at low temperatures and protects the metallic base from the exposure to heat. At very high temperatures, however, a high absorption of the radiation heat would occur in the thermal insulation layer, and the effectiveness of the heat shield would decrease.

In DE 197 50 517 A1, a porous intermediate layer of metal fiber felt is applied, whereby the intermediate layer is to render possible a better active cooling by means of forced convection with a cooling agent. But this cooling is technically very complex and thus unsuitable for vacuum furnaces and protective atmosphere furnaces.

Still other heat shields, e.g., in DE 199 47 755 or DE 36 07 047, are built of porous material and are flowed through by a hot medium (e.g., exhaust gas or reaction products), i.e., a high share of heat is transferred here via convection through the basic conditions of the technical process. Thereby, a high heat conduction is to transfer the heat of the hot medium flowing through to the porous medium, which is to reduce the removal of heat with the medium by means of reflection into the reaction chamber. But for this purpose the emissivity of the surface is to be as high as possible, which, however, is very unfavorable at high temperatures, as a high share of the radiant heat is then absorbed as well.

Materials of particularly good thermal insulation are achieved, i.e., in JP 63263370 or U.S. Pat. No. 5,744,225 through a multiple-layer structure that utilizes the fact that different materials have a different spectral transmittance capacity of thermal radiation.

The object of the present invention is to disclose thermal radiation protective shields of reduced weight with identical or lower effective emissivity.

The object is attained by the invention disclosed in the claims. Advantageous embodiments are the subject of the subordinate claims.

A thermal radiation protective shield for vacuum furnaces and protective atmosphere furnaces according to the invention is composed of at least one porous ceramic and/or metallic material, and has high thermal radiation-reflecting properties at least on one surface in the direction of the heat source.

It is advantageous if the thermal radiation protective shield has an emission coefficient on the surface of 0.03-0.5 in the temperature range of 20-1800° C.

Advantageously, a thermal radiation protective shield according to the invention is made of a ceramic and/or metallic material with a porosity in the range of 80 to 97%, even more advantageously in the range ≧90%.

It is furthermore advantageous if a material with low emission coefficient is applied to the porous ceramic and/or metallic material for the thermal radiation-reflecting properties. It is thereby particularly advantageous if the emission coefficient of the applied material has an emission coefficient of 0.03-0.35 in the temperature range of 20-1800° C. It is also advantageous if this material with low emission coefficient is a metal foil or, even better, an impervious, non-porous metal foil or an impervious layer.

It is also advantageous if the porous ceramic material is a ceramic foam, even more advantageous if it is made of aluminum silicate, silicon nitride, silicon carbide.

It is also advantageous if the porous metallic material is a metal foam, even more advantageous if the metal foam is made of heat-resistant steel alloys, metal alloys or refractory metals, such as molybdenum, tungsten, tantalum, or alloys thereof.

Furthermore, it is advantageous if the porous ceramic foam or the metal foam is an anisotropically structured three-dimensional network, whereby it is even more advantageous if the anisotropic structuring has a lower thermal conductivity of the material perpendicular to the surface in the direction of the heat source than in the parallel direction to the surface in the direction of the heat source.

It is also advantageous if the porous ceramic foam or the metal foam has foam cell widths of 0.2 to 6 mm.

Advantageously, the thermal radiation-reflecting material with low emission coefficient has a thickness of 0.005 to 1.00 mm, even more advantageously of 0.005 to 0.5 mm.

It is also advantageous if the porous ceramic and/or metallic material and the thermal radiation-reflecting material with low emission coefficient are made of the same material, even more advantageous if they are made of a metal and in particular of molybdenum or tungsten or of a molybdenum or tungsten alloy.

Furthermore, the porous ceramic and/or metallic material is advantageously completely surrounded by a thermal radiation-reflecting material with low emission coefficient, whereby, even more advantageously, the thermal radiation-reflecting material with low emission coefficient encloses the porous ceramic and/or metallic material in a vacuum-tight manner, and there is a vacuum in particular in the internal volume enclosed by the thermal radiation-reflecting material with low emission coefficient.

It is also advantageous if the thermal radiation-reflecting material with low emission coefficient has the lowest possible emission coefficient at least on one surface in the direction of the heat source, and at the same time the porous ceramic and/or metallic material has the lowest possible thermal conductivity coefficient, whereby, even more advantageously, the emission coefficient is in the range of 0.03 to 0.5 in the temperature range of 20-1800° C., and at the same time the thermal conductivity coefficient is in the range of 0.01 to 3 W/mK in the temperature range of 20-1800° C. It is particularly advantageous if the emission coefficient is in the range of 0.03 to 0.3 in the temperature range of 20-1800° C., and at the same time the thermal conductivity coefficient is in the range of 0.01 to 1 W/mK in the temperature range of20-1800° C.

Furthermore, it is advantageous if the effective emission coefficient can be calculated according to the formula

$$\frac{1}{{ɛ}_{eff}} = \frac{2}{ɛ} + 4 \cdot σ \cdot {T}_{1}^{3} \cdot \frac{d}{λ} \cdot {( \frac{1}{2} + \frac{1}{2} \cdot \frac{{T}_{0}^{4}}{{T}_{1}^{4}} )}^{\frac{3}{4}}$$

whereby the thermal radiation protective shield then has an effective emission coefficient in the range of 0.001-<0.15 and, advantageously, in the range of 0.001-0.069.

Because of the low thermal conductivity of the porous material, the effective emission coefficient decreases with the thickness. It is possible to use relatively large thicknesses for the porous material, e.g., 5-20 mm, since the mass and the material costs associated with it rise only slightly with increasing thickness because of the porosity of the material. At the same time, the thermal radiation-reflecting material with low emission coefficient on the surface of the porous material, which has a higher density, can be embodied to be a thin as possible, e.g., 0.07 mm. The respective optimum depends on the space conditions available for the respective furnace and the intended weight and/or expenses for the thermal radiation protective shields. This optimum can easily be determined by one skilled in the art.

The solution according to the invention has a much lower weight compared to a thermal radiation protective shield of the prior art. The lower weight is primarily achieved by using porous ceramic and/or metallic material and, furthermore, also by using less material, since the material used according to the invention fulfills the required protective function better because of its thermotechnical properties. The effective emission coefficient can thereby be approximately equal to that of known thermal radiation protective shields, or also lower.

The particular advantage of the thermal radiation protective shields according to the invention compared to thermal radiation protective shields of the prior art lies in that the low emission coefficient at least on one surface in the direction of the heat source of a vacuum furnaces and protective atmosphere furnace leads to the most complete reflection possible of the thermal radiation of the heat source, and allows to penetrate into the material only the lowest possible part of the thermal radiation, whereby at the same time the lowest possible heat conduction is realized in the interior of the material through the use of the porous ceramic and/or metallic material.

Furthermore, the thermal radiation protective shields according to the invention show their advantageous properties only in vacuum furnaces and protective atmosphere furnaces in the high-temperature range from approximately 600° C. Other solutions from the prior art can be used more advantageously for applications in furnaces with lower temperatures.

It is particularly advantageous if the thermal radiation protective shield according to the invention is present in the form of a so-called sandwich structure, whereby a porous to highly porous material is covered completely or in part, e.g., coated with a foil, by a material with low emission coefficient on one side in the direction of the heat source. In turn, this foil can thereby advantageously be made of a high temperature-resistant metal.

In order to save additional costs, the faces and the back of the porous material can be covered with a foil of a cheaper material with comparatively worse properties. With a vacuum-tight seal of the foils around the porous material, the interior space enclosed by the foils can also be evacuated, so that this vacuum also acts as an insulation at the same time.

The connection between the porous material and the thermal radiation-reflecting material can be adhesive and/or positive. With an adhesive connection there are material joints between the materials, e.g., through sintered bridges or soldered joints. With a positive connection the connection is produced, e.g., by mechanical attachments such as counterdrafts or connecting elements such as pins, wires, screws. Both connecting options can be detachable or permanent. With detachable connections it is advantageously possible to also exchange merely individual thermal radiation protective shields or parts of the thermal radiation protective shields in case of wear or failure. Furthermore, it is also possible to transform an originally positive connection into an adhesive connection through the use in a furnace, e.g., by sintering the contact points between the porous material and the thermal radiation-reflecting material. An attachment variant is particularly preferred in which there is the lowest possible heat transfer between the thermal radiation-reflecting material and the porous material.

If foams are used, advantageous foam thicknesses are 2-20 mm, foam cell widths 0.2 to 6 mm, foam densities 3 to 20%, preferably 5 to 10% of the density of the bulk material.

The foam densities lead to a porosity of the porous materials used of 80 to 97%, preferably 90 to 95% of the theoretical density. These high open (i.e., accessible from outside) porosities ensure that the furnace interior space can be evacuated relatively fast.

The thermal radiation-reflecting material according to the invention is advantageously a metal layer with a thickness of 0.005 to 1.00 mm and is as impermeable as possible, i.e., as non-porous as possible or, in the case of a layer, contains only closed pores, if possible.

The thermal radiation-reflecting material according to the invention is as smooth as possible on its surface in the direction of the heat source. This thermal radiation-reflecting material according to the invention acts like a conventional thermal radiation protective shield of the prior art. The subsequent porous material reduces the heat conduction and is at the same time considerably lighter than the conventional thermal radiation protective shields.

In addition, the low heat conduction of the thermal radiation protective shield results in a markedly lower surface temperature of the side of the thermal radiation protective shield facing away from the heat source than on the side facing the heat source. Because of the general temperature dependence of the emission coefficients, which generally causes them to become lower as the temperature decreases, less heat is thus also radiated at the back.

With the use of a high-temperature furnace the surface of the thermal radiation protective shields is often changed by scaling or deposits, which generally causes the emission coefficient to increase, which unfavorably means that more heat is absorbed at the side of the thermal radiation protective shield facing the heat source and is emitted at the back. Eventually, this causes the thermally insulating function of the thermal radiation protective shields to decrease, which also limits their functional service life. Through the reduction of the temperature on the back of the thermal radiation protective shields according to the invention, the effect of the worsening of the emission coefficient—although this occurs to the same extent—is reduced for the reasons mentioned above, which results in a longer functional service life.

Furthermore, the thermal radiation-reflecting material according to the invention can also serve to mechanically stabilize the porous material or vice versa.

An embodiment of the solution according to the invention can be advantageous, in which the weight and the heat capacity are considerably reduced with a surface comparable to conventional thermal radiation protective shields of the prior art with the same heat conduction perpendicular to the surface of the thermal radiation protective shield. With a different embodiment, the heat conduction can be markedly reduced perpendicular to the surface of the thermal radiation protective shield with comparable mass and heat capacity, so that fewer thermal radiation protective shields have to be used in the insulation zone of a furnace.

Thermal radiation protective shields according to the invention, in which the thermal radiation-reflecting layered material and the porous material are made of the same metal, have a density of 5-30% of the pure metal.

Thermal radiation protective shields according to the invention made of molybdenum have a weight of 2-10 kg/m² area and the heat conduction perpendicular to the surface is 0.2-10 W/mK at room temperature and 0.3-15 W/mK at 1000° C. under vacuum atmosphere in the furnace chamber with identical or improved thermal radiation reflection, as compared to a conventional thermal radiation protective shield.

By comparison, a molybdenum sheet of 1 mm thickness has a weight per unit area of 10 kg/m² and a thermal conductivity of 145 W/mK at room temperature and 105 W/mK at 1000° C.

Thermal radiation protective shields according to the invention made of tungsten have a weight of 5-30 kg/m² area and the heat conduction perpendicular to the surface is 0.4-20 W/mK at room temperature and 0.6-30 W/mK at 1000° C. under vacuum atmosphere in the furnace chamber with identical or improved thermal radiation reflection, as compared to a conventional thermal radiation protective shield.

By comparison, a tungsten sheet of 1 mm thickness has a weight per unit area of 19 kg/m² and a thermal conductivity of 165 W/mK at room temperature and 135 W/mK at 1000° C.

If a foam is used, a thermal radiation protective shield according to the invention is produced according to a method known per se. To this end, an open-cell polymer foam is coated with a powder suspension, dried, the polymer is annealed and subjected to a temperature treatment (U.S. Pat. No. 3,090,094 for ceramic foams; U.S. Pat. No. 3,111,396 for metal foams). A different open-cell material that can be removed thermally or chemically can also be used instead of a polymer foam (DE 197 53 249 A1).

The finished foam with the desired dimensions can be used such as a thermal radiation protective shield. Advantageously, it is covered with a thermal radiation-reflecting material according to the invention, advantageously metal foils, on the side in the direction of the heat source or also on the corresponding back, and this material is attached to the foam surface. A positive connection can thereby occur by bending the metal foil around the side edges of the foam or by bending or folding it into existing recesses in the foam or by pressing individual areas of the foil into the open cells of the foam. It is also possible to press hooks, wires, pins out of the foil, which hook into the foam or are inserted into bores in the foam. These fastening elements can also be passed through the foam and attached on the opposite side. Separately manufactured hooks, wires, pins can also be used for fastening.

Furthermore, the foil can be attached to the foam by soldering, even in a locally limited manner, if foam and foil are not made of the same material. In the case of identical materials, sintering is possible, which produces a permanent connection.

Another advantageous option for producing a thermal radiation protective shield according to the invention is the production of a foil of metal powder, application to a preliminary stage of the foam and a joint sintering. To this end, a metal powder suspension is applied to a smooth base and processed into a foil. A polymer foam in the shape of the desired thermal radiation protective shield is also coated with a metal powder suspension and dried. This coated polymer-foam molded part is placed onto the metal foil that is still moist and thus glued together with it. After the initial drying the back is coated with the moist metal foil and drying is started. The foam molded part thus coated is subjected to a temperature treatment, whereby, as the temperature increases, first the polymer foam and the shaping auxiliaries used are burned or thermally disintegrated and escape in a gaseous manner, and subsequently the powder particles sinter. As a result, there is a thermal radiation protective shield according to the invention at the end of the process.

It is also possible to scrape or spread a viscous paste made of a metal powder onto a green or sintered foam and to sinter it after initial drying.

Furthermore, it is possible to produce a thermal radiation protective shield according to the invention by applying a thin textile flat shaped article in the form of a woven, knit or non-woven fabric of metal wire onto a sintered or green foam and by filling the gaps between the metal wires, e.g., by spraying and subsequent drying and sintering.

In particular thin layers of thermal radiation-reflecting material can be applied by known coating methods, e.g., via thermal spraying, PVD or CVD.

It is also possible to apply a thin mat of polymer fibrous material or natural fibrous material, e.g., in the form of a woven, knit or non-woven fabric onto the sintered or green foam. This mat can thereby already be pre-soaked in a metal suspension or be coated with this suspension by subsequent knife coating or spraying. After drying, the polymer fibrous material or natural fibrous material is thermally disintegrated or burned by the further temperature treatment, before the metal foam sinters. Thin mats of fine-pored, open-cell polymer foam material can also be used instead of fibrous materials.

After the connection of foam and foil the sandwich compound can be deformed. It is thus possible to, e.g., carry out a rolling to a smaller thickness of the thermal radiation protective shield. Essentially the foam is thereby deformed. The thermal radiation protective shield can also be bent, folded or edged, so that it is possible to produce different geometries for the desired place of use.

The invention is described in more detail below on the basis of exemplary embodiments.

### EXAMPLE 1

A thermal radiation protective shield according to the invention is composed of an open-cell molybdenum foam with a porosity of 90%, a density of 1.02 g/cm³ and an average cell width of 0.2 mm; the thickness of this radiation protective shield is 5 mm.

The weight per square meter area of this thermal radiation protective shield is 5.1 kg. The thermal conductivity perpendicular to the surface in vacuum is 0.6 W/mK at room temperature, 1 W/mK at 1000° C. The heat reflection on the surface is somewhat lower than that of conventional molybdenum thermal radiation protective shields, the emission coefficient at 1000° C. is approximately 0.35. The effective emission coefficient in vacuum at 1000° C. is 0.14.

By comparison, a conventional molybdenum thermal radiation protective shield with a thickness of 0.8 mm has a density of 10.2 g/cm³ and a weight per unit area of 8.2 kg/m². The heat conduction is 145 W/mK at room temperature and 105 W/mK at 1000° C. The emission coefficient at 1000° C. is 0.3. The effective emission coefficient in vacuum at 1000° C. is 0.15.

With the thermal radiation protective shield according to the invention it is possible to achieve a better thermal insulation effect in a vacuum furnace with the same number of thermal radiation protective shields, than with conventional thermal radiation protective shields. The thermal radiation protective shields according to the invention use 38% molybdenum, i.e., correspondingly less weight and heat capacity.

### EXAMPLE 2

A thermal radiation protective shield according to the invention is composed of a sandwich with a core of 5 mm thickness made of open-cell molybdenum foam with a density of 0.51 g/cm³ and an average cell width of 0.8 mm, which sandwich is coated on both sides with a molybdenum foil of 0.1 mm thickness and connected in an adhesive manner by sintering. The density of this thermal radiation protective shield is 0.88 g/cm³.

The weight per square meter area of this thermal radiation protective shield is 4.6 kg. The thermal conductivity perpendicular to the surface in vacuum is 0.2 W/mK at room temperature, 0.9 W/mK at 1000° C. The heat reflection on the surface is equal to that of conventional molybdenum thermal radiation protective shields, with polished sheet of 0.14. The effective emission coefficient in vacuum is 0.063 at 1000° C., 0.062 at 1500° C.

By comparison, a conventional polished molybdenum thermal radiation protective shield with a thickness of 0.8 mm has a density of 10.2 g/cm³ and a weight per unit area of 8.2 kg/m². The heat conduction is 145 W/mK at room temperature, 105 W/mK at 1000° C. and 90 W/mK at 1500° C. The effective emission coefficient in vacuum at 1000° C. and 1500° C. is 0.070.

1. Thermal radiation protective shield for vacuum furnaces and protective atmosphere furnaces, comprising at least one porous metallic material that has high thermal radiation-reflecting properties at least on a surface in a direction of the heat source.

2. Thermal radiation protective shield according to claim 1, having an emission coefficient of 0.03-0.5 on a surface in a temperature range of 20-1800° C.

3. Thermal radiation protective shield according to claim 1, wherein the at least one porous metallic material has a porosity of 80 to 97%.

4. Thermal radiation protective shield according to claim 3, wherein the porosity of the at least one porous metallic material is ≧90%.

5. Thermal radiation protective shield according to claim 1, further comprising a material with low emission coefficient and thermal radiation-reflecting properties applied to the at least one porous metallic material.

6. Thermal radiation protective shield according to claim 5, wherein the emission coefficient of the applied material with low emission coefficient is 0.03-0.35 in a temperature range of 20-1800° C.

7. Thermal radiation protective shield according to claim 5, wherein the thermal radiation-reflecting material with low emission coefficient is a metal foil.

8. Thermal radiation protective shield according to claim 5, wherein the thermal radiation-reflecting material is an impervious, non-porous metal foil or an impervious layer.

9. (canceled)

10. (canceled)

11. Thermal radiation protective shield according to claim 1, wherein the at least one porous metallic material is a metal foam.

12. Thermal radiation protective shield according to claim 11, wherein the metal foam is made of heat-resistant steel alloys, metal alloys or refractory metals.

13. Thermal radiation protective shield according to claim 11, wherein the metal foam is an anisotropically structured three-dimensional network.

14. Thermal radiation protective shield according to claim 13, wherein the anisotropically structured three-dimensional network has a lower thermal conductivity of material perpendicular to the surface in the direction of the heat source than in a direction parallel to the surface in the direction of the heat source.

15. Thermal radiation protective shield according to claim 11, wherein the metal foam has a width of 0.2 to 6 mm.

16. Thermal radiation protective shield according to claim 5, wherein the thermal radiation-reflecting material with low emission coefficient has a thickness of 0.005 to 1.00 mm.

17. Thermal radiation protective shield according to claim 16, wherein the thermal radiation-reflecting material with low emission coefficient has a thickness of 0.005 to 0.5 mm.

18. Thermal radiation protective shield according to claim 5, wherein the at least one porous metallic material and the thermal radiation-reflecting material with low emission coefficient are made of the same material.

19. Thermal radiation protective shield according to claim 18, wherein the same material is a metal.

20. Thermal radiation protective shield according to claim 19, wherein the same material is molybdenum or tungsten or a molybdenum alloy or tungsten alloy.

21. Thermal radiation protective shield according to claim 1, wherein the at least one porous metallic material is completely surrounded by a thermal radiation-reflecting material with low emission coefficient.

22. Thermal radiation protective shield according to claim 21, wherein the thermal radiation-reflecting material with low emission coefficient encloses the at least one porous metallic material in a vacuum-tight manner.

23. Thermal radiation protective shield according to claim 22, wherein there is a vacuum in an internal volume enclosed by the thermal radiation-reflecting material with low emission coefficient.

24. Thermal radiation protective shield according to claim 5, wherein the thermal radiation-reflecting material with low emission coefficient has a lowest possible emission coefficient at least on a surface in the direction of the heat source, and at the same time the at least one porous metallic material has a lowest possible thermal conductivity coefficient.

25. Thermal radiation protective shield according to claim 24, wherein the emission coefficient of the thermal radiation-reflecting material with low emission coefficient is in a range of 0.03 to 0.5 in a temperature range of 20-1800° C., and at the same time the thermal conductivity coefficient of the at least one porous metallic material is in a range of 0.01 to 3 W/mK in a temperature range of 20-1800° C.

26. Thermal radiation protective shield according to claim 24, wherein the emission coefficient of the thermal radiation-reflecting material with low emission coefficient is in a range of 0.03 to 0.3 in the temperature range of 20-1800° C., and at the same time the thermal conductivity coefficient of the at least one porous metallic material is in a range of 0.01 to 1 W/mK in the temperature range of 20-1800° C.

27. Thermal radiation protective shield according to claim 1, having an effective emission coefficient is calculated according to the formula
$$\frac{1}{{ɛ}_{eff}} = \frac{2}{ɛ} + 4 \cdot σ \cdot {T}_{1}^{3} \cdot \frac{d}{λ} \cdot {( \frac{1}{2} + \frac{1}{2} \cdot \frac{{T}_{0}^{4}}{{T}_{1}^{4}} )}^{\frac{3}{4}}$$
and is in the range of 0.001-<0.15.

28. Thermal radiation protective shield according to claim 27, wherein the effective emission coefficient is in the range of 0.001-0.069.

29. Thermal radiation protective shield according to claim 11, wherein the metal foam is made of molybdenum, tungsten, or tantalum, or alloys thereof.

30. In combination, a thermal radiation protective shield according to claim 1 and a vacuum furnace or protective atmosphere furnace.

31. In combination, a thermal radiation protective shield according to claim 5 and a vacuum furnace or protective atmosphere furnace.

32. A method of protecting a vacuum furnace or a protective atmosphere furnace comprising including a thermal radiation protective shield according to claim 1 in the vacuum furnace or the protective atmosphere furnace.

33. A method of protecting a vacuum furnace or a protective atmosphere furnace comprising including a thermal radiation protective shield according to claim 5 in the vacuum furnace or the protective atmosphere furnace.
